(19) United States
(12) Patent Application Publication
(10) Pub. No.: US 2011/0276770 A1
(43) Pub. Date: Nov. 10, 2011

(54) METHOD AND SYSTEM FOR ANALYSING MOST RECENTLY USED REGISTRY KEYS

(75) Inventors: Yuandong Zhu, Dublin (IE); Pavel Gladyshev, Dublin (IE)

(73) Assignee: UNIVERSITY COLLEGE DUBLIN, NATIONAL UNIVERSITY OF IRELAND, DUBLIN, Dublin (IE)

(21) Appl. No.: 13/144,743

(22) PCT Filed: Jan. 19, 2010
(86) PCT No.: PCT/EP2010/000274

§ 371 Date: Jul. 15, 2011

(30) Foreign Application Priority Data
Jan. 19, 2009 (IE) S2009/0054
Mar. 16, 2009 (IE) S2009/0211

(51) Int. Cl. G06F 12/02

(52) U.S. Cl. 711/160; 711/E12.002

(57) ABSTRACT

A method is disclosed for analysing a computing device including a non-volatile storage medium in which a set of snapshots is stored. Each snapshot comprises at least one most recently used, MRU, key for an application, at least one MRU key having a plurality of elements. The method comprises comparing a first MRU key from a first snapshot for a first time and a corresponding second MRU key for a second snapshot for a second time temporally following said first time. If the second MRU key has a second element identified as less recently used than a first element of the second MRU key and the second element of the first MRU key is identified as not being less recently used than the first element of the first MRU key, the first element is labelled as having been newly modified between the first and second times.

### FIELD OF THE INVENTION

This invention relates to a method and system for analysing Most Recently Used, MRU, lists, and in particular, for analysing registry MRU keys.

### BACKGROUND OF THE INVENTION

Operating systems, OS, such as Mac OS, Linux or Microsoft Windows comprise a directory or registry arranged to store and update settings associated with the OS, for example, information relating to hardware, software, user options, file associations, system policies, PC preferences etc.

The Microsoft Windows Registry comprises a plurality of logical sections called hives. Each hive comprises keys in which information relating to a specific aspect of the OS is stored. For example, hive HKEY_CURRENT_USER comprises a key in which settings specific to the currently logged-on user are stored, whereas, hive HKEY_LOCAL_MACHINE comprises a key in which settings common to all users of the device are stored. Each registry key has an associated timestamp, which is updated when a data value within the registry key is modified. However, the only time information inferable about other data values within the key is that any modifications made to them occurred at some time prior to current timestamp.

In order to allow for the rolling back of system files, registry keys, installed programs, etc., to a previous state in the event of malfunctioning or failure, Microsoft Windows employ a System Restore component. System Restore essentially comprises a plurality of ‘snapshots’ of the Registry, known as system restore points, which are acquired and recorded periodically in order to back up the Registry. In general, the Microsoft Windows Registry is backed up every 24 hours, and automatically, in response to certain activities, for example, the installation of new software.

Since the system restore points are associated with a creation timestamp, they can be employed to reset the state of the system to that of a particular date and time. For example, in the situation where a system is rebooting after a crash, the system restore point corresponding to the most recent snapshot of the Registry is accessed in order to retrieve and reset system parameters and preferences. Similarly, system restore points may be employed to revert to those system parameters and preferences of a specific date and time.

A forensic investigator analysing the registry and/or consecutive system restore points will be capable of inferring information related to activities which have occurred on the system. This is due to the fact that most registry keys are updated by replacing old data with new data and are easily analysed to provide a clear picture of those activities. However, Most Recently Used, MRU, keys, which comprise a list of programs or documents that were most recently accessed, are modified in a different manner, and as such, the same methods of forensic analysis are not appropriate and may not produce accurate results.

### DISCLOSURE OF THE INVENTION

Accordingly, the present invention provides a method for analysing a computing device, the computing device including a non-volatile storage medium in which a set of snapshots is stored, each snapshot comprising at least one most recently used, MRU, key for an application, at least one MRU key having a plurality of elements, said method comprising: comparing a first MRU key from a first snapshot for a first time and a corresponding second MRU key for a second snapshot for a second time temporally following said first time; responsive to said second MRU key having a second element identified as less recently used than a first element of said second MRU key and identifying said second element of said first MRU key as not being less recently used than said first element of said first MRU key, labelling said first element as having been newly modified between said first and second times.

Preferably, said snapshot is of an operating system registry at a respective time, wherein the registry comprises the at least one most recently used, MRU, key for an application.

Preferably, said snapshot is stored within a system restore point.

Preferably, the method includes the step of: responsive to identifying an element as newly modified and identifying any elements more recently used than said newly modified element in said second MRU key, labelling said more recently used elements as newly modified.

Preferably, said comparing comprises converting said first and second MRU keys into respective ordered lists of elements, wherein a MRU element is positioned at an end of the list, with lesser recently used elements being positioned therefrom in order of decreasing use.

In another aspect of the present invention, there is provided a method for analysing a computing device, the computing device including a non-volatile storage medium storing folder information for a windows type operating system and a set of snapshots, each snapshot comprising at least one most recently used, MRU, key indicating user interaction with folders of said operating system during operation of said computing device, at least one MRU key having a plurality of MRU items relating to respective folders, said method comprising:

for at least one folder of said operating system, comparing a related MRU item of first MRU key from a first snapshot for a first time and a corresponding MRU item of a second MRU key for a second snapshot for a second time temporally following said first time including applying a plurality of conditions to said MRU items to determine whether a user interaction event occurred during an elapsed time period separating the two snapshots.

Preferably, said method further comprises responsive to an event being determined as having occurred, marking a folder associated with the MRU item as having been used or not used.

According to still another aspect of the present invention, there is provided a method for analysing a computing device, the computing device including a non-volatile storage medium storing folder information for a windows type operating system, said folders comprising at least one file, and a set of snapshots, each snapshot comprising an item having a timestamp, and said method comprising: traversing said snapshots to locate a value for a folder, having an associated first timestamp, in a first snapshot of said set of snapshots; responsive to locating the first value, traversing said remaining snapshots to locate corresponding values for said folder, each having an associated second timestamp, temporally spaced from said first timestamp; and indicating user interaction with folders of said operating system during operation of said computing device in accordance with the timestamps of different values for folders from different snapshots.

Preferably, the timestamp associated with the value is identified when comparing the first snapshot with a preceding snapshot and the value is changed.

Preferably, said method further comprising identifying changed files within the folder in a time period elapsed between the first and second timestamps.

Preferably, said value is an ItemPos item, and said item is a Shell key containing said ItemPos.

In a further aspect there is provided, a computer implemented registry analysis tool arranged to carry out the method of the present invention.

In a still further aspect of the invention, there is provided a computer program product comprising a computer readable medium storing and/or recording instructions in machine readable form which when executed in a computing device cause the computing device to carry out the steps of the method of the present invention.

### BRIEF DESCRIPTION OF THE DRAWINGS

Embodiments of the invention will now be described, by way of example, with reference to the accompanying drawings, in which:

FIG. 1a is a screen shot depicting a first state of a typical stacked MRU key;

FIG. 1b is a screen shot depicting a second state of the stacked MRU key of FIG. 1a;

FIG. 2a is a screen shot of a typical linked list indicator of an MRU key;

FIG. 2b a screen shot depicting a second state of the linked list indicator of the MRU key of FIG. 2a;

FIG. 3a is a screen shot depicting the typical stacked MRU key of FIG. 1 being converted into an ordered MRU list according to the preferred embodiment of the present invention;

FIG. 3b is a screen shot of the typical linked list indicator of an MRU key of FIG. 2 being converted into an ordered MRU list according to the preferred embodiment of the present invention;

FIG. 4 is a flow diagram illustrating updating of the ordered MRU list of FIG. 2b and FIG. 3b, in response to a request to add a new element to the MRU key, according to the preferred embodiment of the present invention;

FIG. 5 illustrates four states of an example of an ordered MRU list according to a preferred embodiment of the present invention;

FIG. 6 is a flow diagram illustrating steps carried out by a registry analysis tool according to the preferred embodiment of the present invention;

FIG. 7a is a screen shot depicting a structure of a sub key, BagMRU, within a windows registry hive;

FIG. 7b is a screen shot depicting a structure of a sub key, Bags, within the windows registry hive;

FIG. 8 is a screen shot of an MRU key of the BagMRU key of FIG. 7a;

FIG. 9 shows generally the system operations resulting from different user actions used by the method of the second aspect of the present invention;

FIG. 10 is a flow diagram illustrating steps carried out by a registry analysis tool according to one implementation of a second aspect of the present invention;

FIG. 11 illustrates an updating example analysed by the method of the second aspect of the present invention; and

FIG. 12 illustrates a MRU item within a BagMRU key corresponding to a folder ‘Test’.

### DESCRIPTION OF THE PREFERRED EMBODIMENTS

In any operating system, it is accepted that Most Recently Used, MRU, lists comprise a list of programs or documents that were most recently accessed. The Microsoft Windows Registry comprises multiple registry keys, including MRU keys, which include a list of data values most recently used in accordance with a particular user activity on the system. For example, an MRU key “HKCU\Software\Microsoft\Office\12.0\Word\File MRU” stores a list of Microsoft Word 2007 documents that were most recently used by a user.

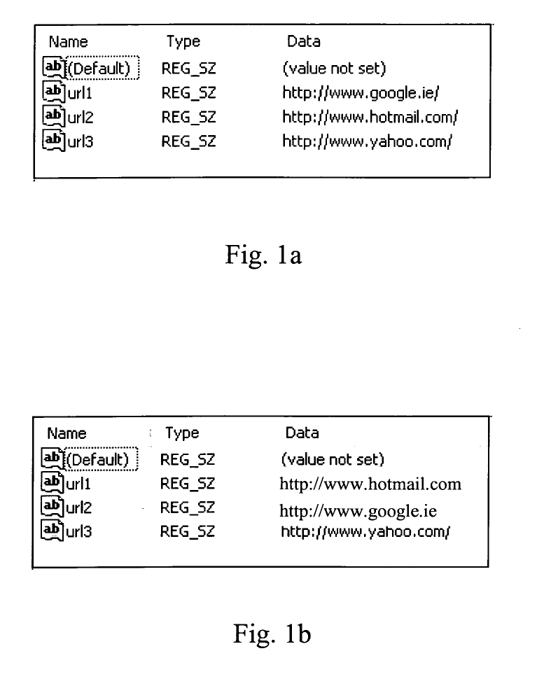

FIG. 1a is a screen shot depicting a typical stacked MRU key, in this case, of invoked URLs. The key comprises three columns, displaying a name of the file, a type associated with the file, and the data value, or actual URL that was entered. In such a stacked list, the most recently invoked URL file, i.e., “http://www.google.ie/” is displayed at the top of the stack and is assigned the name ‘url1’.

If a different URL, for example, “http://www.hotmail.com/” is subsequently invoked, the key is updated as illustrated in FIG. 1b, by renaming the file comprising the URL “http://www.hotmail.com/”, url1 and placing it at the top of the stack. Consequently, the file previously named url1, is renamed url2, and is pushed down the stack to a second position.

Thus, in the stacked list version, the file name associated with the URL data value comprises a number indicating the order of the data value in the list. In order to update the key, the files comprising the data values are renamed to maintain the order within the MRU key.

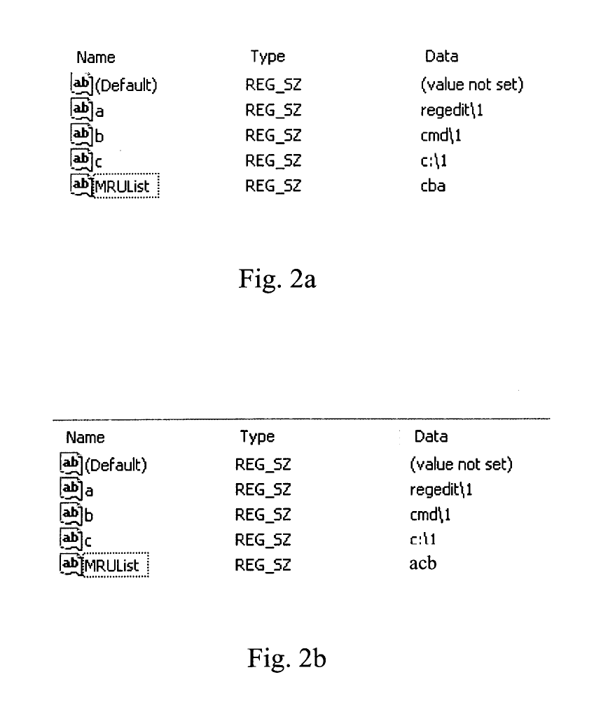

FIG. 2a is a screen shot depicting a typical linked list indicator of an MRU key, in this case, of entered commands. The key comprises three columns, displaying a name of the file, a type associated with the file, and the data value, or actual command that was typed. The key comprises a file, in this case, MRUlist, comprising a linked list value displaying the order of the other data values of the list. The leftmost file name in the linked list corresponds with the most recently updated value in the list, i.e., the most recently invoked command.

Thus, in the first instance, as depicted in FIG. 2a, it can be seen that the most recently entered command was that of file name “c”, i.e., “c:\1”, since the file “MRUlist” displays file “c” in the leftmost position of the linked list. If a different command, for example, “regedit\1”, is subsequently entered, the list is updated as illustrated in FIG. 2b, by reordering the linked list to position the file name of the file comprising the command, “regedit\1”, in the leftmost position, with the second most recently entered command file name being moved to the second leftmost position of the list.

In the linked list version of the MRU key, only the linked list entry is altered after a modification of any data value occurs, with the file names of the data values remaining unaltered. However, in the stacked list version of the MRU key, some files are renamed after a modification of data value occurs even they are not related to the cause of modification directly. For example, although the url1 value was renamed url2, no user action changed the content of that value. Thus, when comparing two consecutive snapshots of a stacked list type of MRU key, it cannot be inferred that the content of a changed file in the MRU key was entered, selected, or otherwise produced by a direct user action, as opposed to an indirect user action to another file in the MRU key.

From a comparison of consecutive system restore points of an MRU key, data values modified during the elapsed period can be identified and as such, it can be inferred that an activity resulting in the modification of the data value must have occurred during the elapsed period. However, in order to ascertain data values that were definitely modified by direct user action, according to the preferred embodiment of the present invention, the manner in which the MRU key is updated is considered.

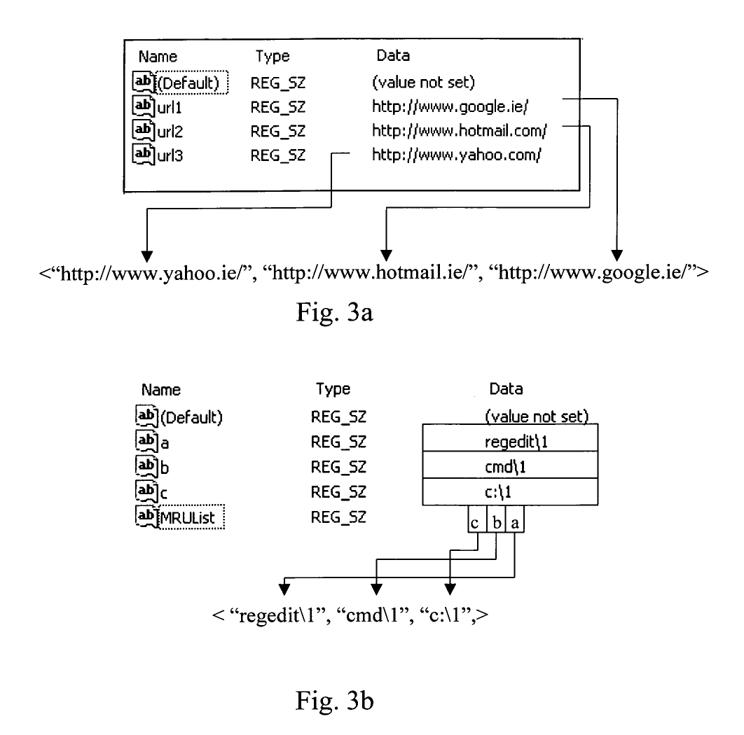

In the preferred embodiment, the stacked MRU key and the linked list indicator MRU key, are converted to a common model representation of an ordered MRU list, as illustrated in FIG. 3a and FIG. 3b, respectively. The ordered MRU list comprises a list of the data values of the MRU key, with the most recent entry of the MRU list being placed in the right most position, at an end of the list, with the each lesser recently used data values being positioned to the left in order of descending use, and the least recent entry placed in the left most position.

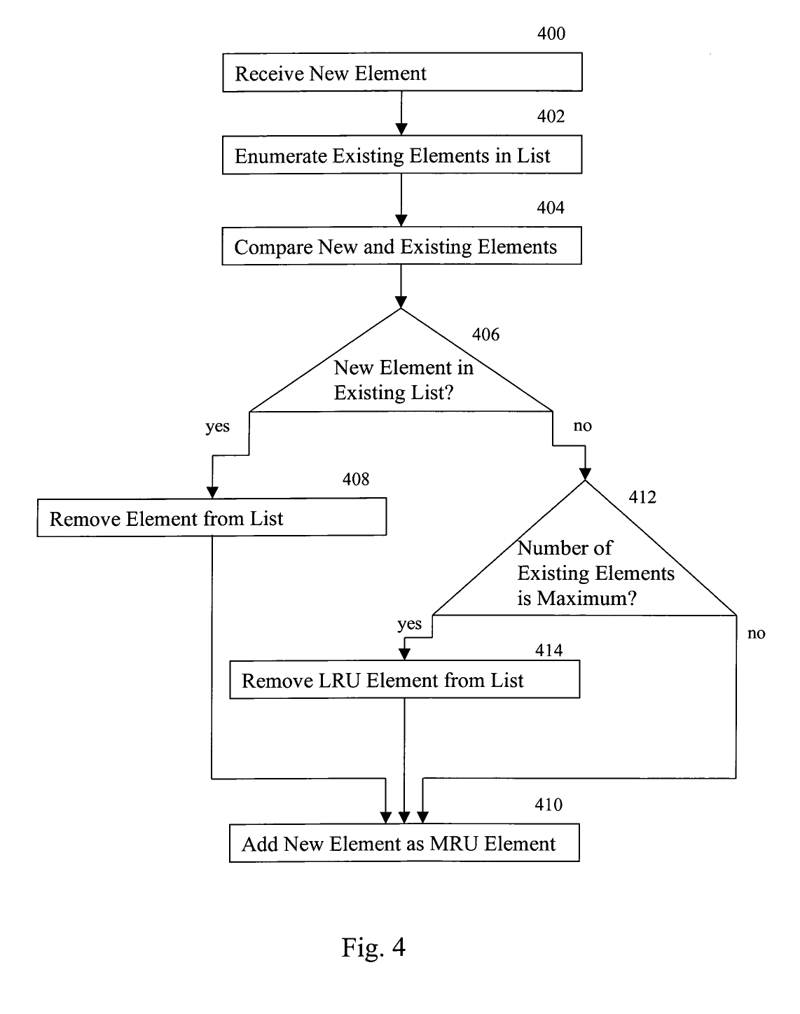

FIG. 4 is a flow diagram depicting steps carried out by the system in the preferred embodiment, in order to update the ordered MRU list in response to a request to add a new element to the MRU key. When a request to add an element to the list is received 400, the system enumerates 402 the elements of the existing MRU list and compares 404 each element with the new element. If the new element appears in the list 406, it is removed 408 from its current position and reinserted 410 in the rightmost position as the most recently used, MRU. If the new element does not appear in the existing list 406, and the number of elements in the key hasn't reached a maximum 412, the new element is added 410 to the existing list in the rightmost position. If the new element does not appear in the existing list 406, and the number of elements in the key has reached a maximum 412, the least recently used, LRU, element, in the leftmost position is removed 414 from the existing list, and the new element is added 410 to the list in the rightmost position.

It will be appreciated that in an alternative embodiment, some elements are removed on receipt of a request to a new element to the MRU key, regardless of whether or not the number of elements in the key is a maximum.

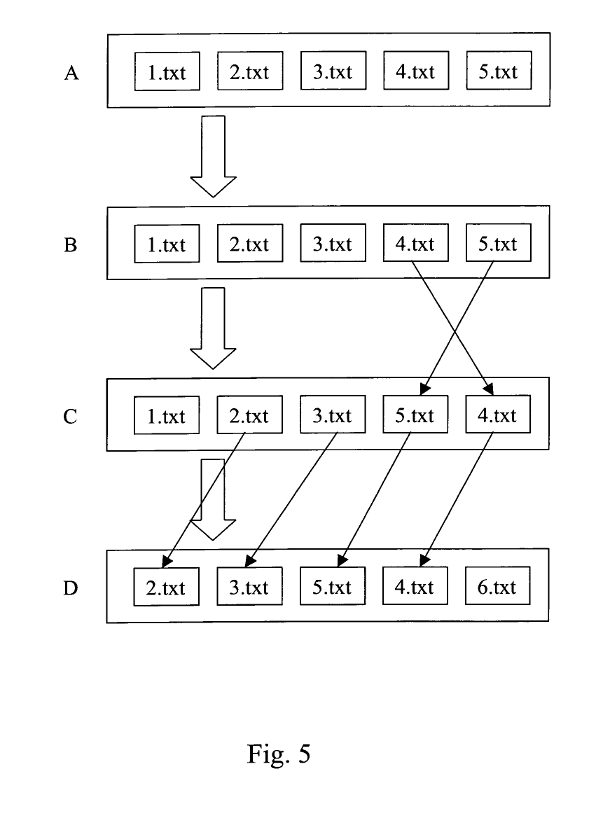

Referring now to FIG. 5, there is illustrated four states of an ordered MRU list comprising a maximum of five elements, 1.txt, 2.txt, 3.txt, 4.txt, and 5.txt. In the first state, A, as illustrated, element 1.txt holds the LRU position of the list, with element 5.txt placed in the MRU position of the list.

When element 5.txt is to be added to the list, as illustrated in the second state, B, no change is made to the list, as 5.txt is in the existing list as the MRU element.

Subsequently, when 4.txt is to be added to the list, as depicted by the third state, C, it is removed from its current position in the existing list, and is replaced in the list in the position of the MRU element. The previous MRU element is thus moved to the position of the second MRU element.

When a new element, 6.txt is to be added to the list, the LRU element, in this case 1.txt, is removed and all remaining elements in the list are shifted one position to the left, towards the LRU position. The element 6.txt is then placed as the MRU element in the rightmost position of the list, as illustrated by state D.

Thus, the final state of the list comprises the elements in the following order: “2.txt, 3.txt, 5.txt, 4.txt, 6.txt”. Despite the fact that elements 2.txt and 3.txt are in new positions in the list, no direct user action to the element was carried out.

An element can be identified as newly updated if there is a less recently used positioned element in the current state of the list that did not appear in the previous state of the list. For example, referring to states B and C of the MRU list of FIG. 5, 5.txt moves from the MRU position in state B to a less recently used position than 4.txt in state C.

Since a new element is always appended to the MRU position of the list, it can be inferred that once an element has been identified as newly updated, every element occurring in a more recently used position of the list to that element, must also have been newly updated.

For example, consider the situation whereby the ordered MRU list of FIG. 5 changes from state B to state D. 4.txt can be identified as being newly updated as 5.txt did not appear in a less recently used position in state B. Thus, it can be assumed that element 6.txt has also been updated as it occurs in a more recently used position than that of identified newly updated 4.txt.

However, despite the fact that the element 5.txt has been added, the order of the elements of the MRU list in state B remain the same as the order of the elements of the MRU list in state A. Thus, user action that does not alter the order of the elements in the MRU list is not identifiable.

Thus, it can be inferred that elements 4.txt and 6.txt were definitely newly updated elements, whereas elements 2.txt, 3.txt and 5.txt can be identified as possibly newly updated elements.

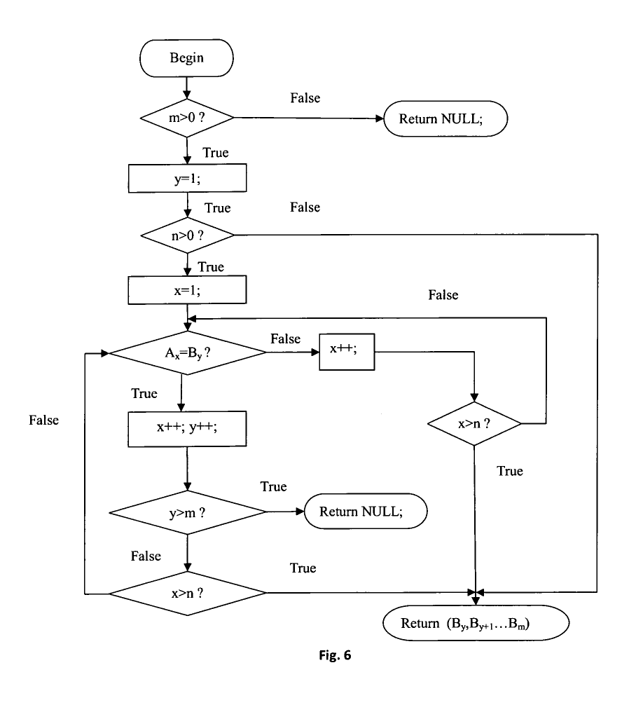

Referring now to FIG. 6, there is illustrated a flow diagram depicting steps carried out by a registry analysis tool according to the preferred embodiment of the present invention. The tool is arranged to access a first list A, which corresponds to an ordered list of n MRU elements of a registry restore point at a first state, and a second list B, which corresponds to an ordered list of m MRU elements of the registry restore point at a second state.

The application tool begins by determining whether there is at least one element in the MRU list B. If there is no element in the list B, the application returns a null pointer as no updated information can be determined.

If there is at least one element in the list B, a first counter y is assigned a value of one, and the application ascertains whether there is at least one element in the list A. If there is no element in the list A, the elements of the list B are all identified as having been modified.

On the other hand, if there is at least one element in list A, a second counter x is assigned a value of 1. In order to compare the values of the two lists, each element of list A is compared with a first element of list B. If no element in list A is found to be equal to the first element in list B, the elements of the list B are all identified as having been modified, and the application outputs the entire list of elements of list B. If an element in list A is found to be equal to the first element in list B, the application continues and compares the second element in list B with each element of list A identified as being more recently used than that which was identified as being equal to the first element of B.

Once the second element of list B is located in list A, the application proceeds to locate the third element and so on. The process terminates when element B_{y} cannot be found in list A (return elements starting from B_{y} until the last element of list B) or each element of list B has been located in list A (return null).

One example of the application of the above method is within a registry analysis tool used in the field of forensic investigation of computers. Including this functionality within such a registry analysis tool provides forensic investigators with a comprehensive picture of activities that occurred on the computer system thereby enabling identification of the nature of illegal or unauthorised activities, or identification of a source of operating system problems, such as, identifying files that may have caused the computer to crash when opened.

Due to the fact that each user logging on to a computer will have a respective subkey under the root HKEY_CURRENT_USER containing specific detail on any application that gets used by that user, forensic investigators may avail of the tool in order to rapidly establish a history of activity associated with each user of a computer.

Other applications, which can use the above method to provide knowledge of a user's history of activity, include commercial applications, such as personalised advertising.

It will be further appreciated that the present application may be employed for comparison of any type of MRU list where two states of the MRU list at two distinct times are available. For example, some applications like the Google Search Toolbar tend to save user activities in the MRU list format in a file. The present invention may be employed when analysing snapshots of these files to identify definitely, user activities which happened during certain periods of time. Furthermore, mobile phones tend to store numbers dialled and messages sent in MRU lists, and as such, the present invention may be employed for mobile forensics.

In a further aspect, the registry analysis tool of the present invention is adapted for specific analysis of file systems to ascertain those folders used by users.

Many hives of the registry comprise keys associated with folders of the windows file system as well as information pertinent to user window viewing preferences of those folders, such as folder/window size, order method, and viewing method. This information, referred to as “ShellBag information”, is stored in folders Software/Microsoft/Windows/Shell and Software/Microsoft/Windows/ShellNoRoam, of hives such as, FIKEY_CURRENT_USER and HKEY_USERS. Thus, the ShellBag information stored in a specific user's hive denotes the viewing preferences of that user.

The Shell folder is arranged to store information relating to a remote folder, whereas the ShellNoRoam folder is arranged to store information relating to a local folder. The structure of each of these folders is identical.

Each folder, Shell, and ShellNoRoam, comprises a sub key, BagMRU, and a sub key, Bags.

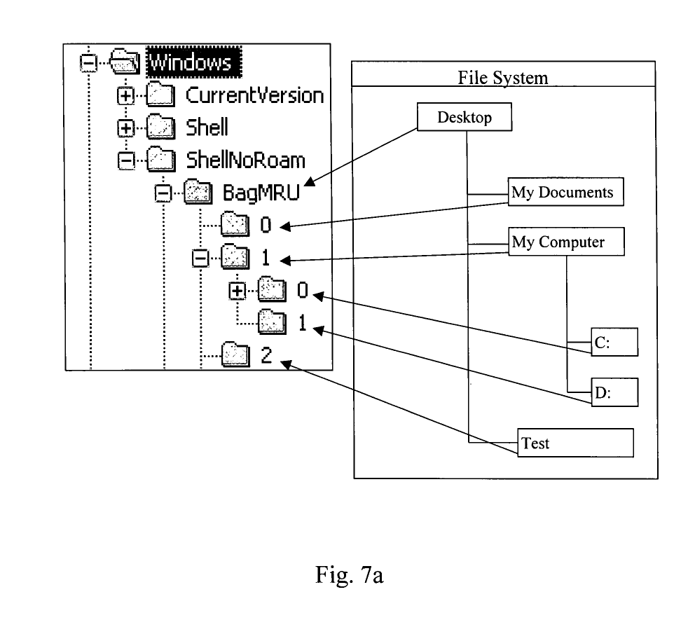

Referring to FIG. 7a, there is illustrated a screen shot of the structure of the BagMRU key. As illustrated, BagMRU comprises a plurality of sub-keys, organised in a hierarchical manner, and each named by a numerical value. Each numerically named sub-key corresponds to a folder in a file system of the computing device. The BagMRU key comprises a pointer to a Desktop folder of the computing device.

For example, as illustrated, the BagMRU key corresponds with the Desktop folder, and comprises sub keys “0”, “1” and “2”, which correspond with folders “Test”, “My Computer” and “My Documents”, respectively. Sub key “1” further comprises subkeys “0” and “1”, which correspond with folders “C:” and “D:” respectively.

A screen shot of the Bags key structure is illustrated in FIG. 7b. The Bags key comprises a plurality of numerically named sub-keys, each comprising a “Shell” key wherein information relating to the viewing or display preferences of the associated folder in the file system is stored. For example, such information comprises window size, window position, sort order, and view mode.

The BagMRU key and each subkey of the BagMRU key comprises an MRU key arranged to denote a sequence of most recently used, MRU, items which correspond with sub-folders of the key's associated folder. Each MRU item is provided with a numerical name. The MRU key further comprises a value “MRUListEX” for recording the sequence of these MRU items, and a “NodeSlot” value, which indicates one of these numerically named subkey of the Bags Key, referred to as “Display key”, corresponding to the MRU key. The Display key comprises a subkey Shell for storing the folder's viewing preferences.

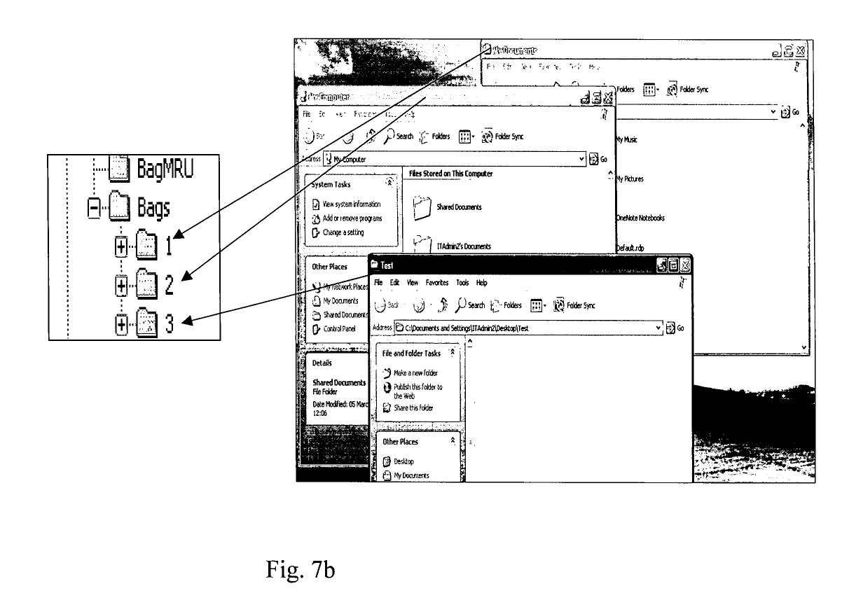

Referring to FIG. 8, the BagMRU key corresponding to the Desktop folder comprises a MRU key. As illustrated in FIG. 7a, the BagMRU key comprises subkeys, “0”, “1”, and “2”, each of which are represented as an MRU item having a corresponding name in the MRU key. For example, the folder “desktop/test” is associated with the key “BagMRU/2”, and as such, all MRU keys and MRU items related to any sub-folders of the folder “test” can also be found in corresponding subkeys of the “BagMRU/2”.

The “NodeSlot” value denotes a location of a Display key in the Bags key where information relating to display preferences for the MRU key may be retrieved.

ShellBag information is created and updated in accordance with interactions to which folders of a file system of a computing device are subjected.

Consider the case where the computing device comprises a folder named “target folder” stored on its desktop. If the folder has been opened and closed at least once, ShellBag information associated with the file will have been created and stored.

When a user reopens “target folder”, the system updates the BagMRU key's “MRUListEx” item with a new sequence of data to reflect the target folder as the most recently used item.

Furthermore, when the user subsequently closes “target folder A”, information relating to the display settings of the folder at the time the file was closed, is recorded in the Shell key under the folders associated Display key of the Bags key.

However, consider the case where the folder being opened and closed is stored in a sub directory of the desktop, i.e., a subfolder of a folder stored on the desktop, for example, sub folder, “target folder B”, of folder “target folder A”.

In this case, the system firstly updated the position of the MRU item in the BagMRU key, the BagMRU key being associated with the ancestor, the desktop, of the used folder, “target folder B”.

The position of the MRU item of the MRU key associated with the parent folder, i.e. “target folder A”, was then updated.

Thus, the system propagated down the hierarchical structure, updating the position of the MRU items such that each ancestor folder is repositioned as the MRU item in their parent's MRU key.

Similarly, when closing a folder directly stored on the desktop, i.e., a subfolder of a folder stored on the desktop, for example, sub folder, “target folder B”, of folder “target folder A”, the MRU updating process begins with the updating of the BagMRU key and propagates down the structure until the MRU key corresponding with the parent folder has been updated.

Now, when a user opens a folder that does not have any associated ShellBag information, for example, a folder that has not been opened and closed before, no new ShellBag information is created. Once the user opens the folder, the MRU updating process begins with the updating of the BagMRU key and propagates down the structure until it cannot find a MRU item match with the folder within its parent folder's MRU key. However, when this folder is subsequently closed, ShellBag information associated with the folder is created.

In this case, on receipt of the command to close the folder, the system again determines that no ShellBag information exists for the folder. The system then sends a request to the registry to create a new item in the BagMRU key, and also to create a new MRU key associated with the folder, under the BagMRU key. The system also updates the “MRUListEx” value of the BagMRU key to reflect the newly created item as the most recently used item.

A new Display key is also created and the view preference settings of the folder are written to a Shell key, the child of the Display key.

In the case where the newly opened folder is not directly stored on the desktop of the computing device, the ancestor MRU items associated with the folder are updated accordingly in the manner described above.

When a folder is deleted, either directly from the desktop, or indirectly, from a sub folder of a directory of the desktop, the folder and its ancestors' MRU items' position will be updated but the ShellBag information will not be deleted.

In the case where a new folder is created having the same name as a previously deleted folder, the ShellBag information associated with the previous, now deleted folder, becomes associated with the newly created folder. In other words, the new folder inherits the ShellBag information associated with the previous folder. Subsequent interaction with the new folder will cause the ShellBag of this folder to be updated accordingly.

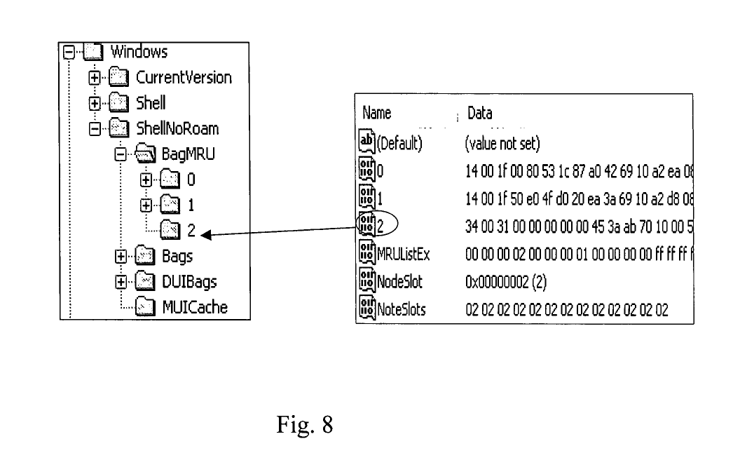

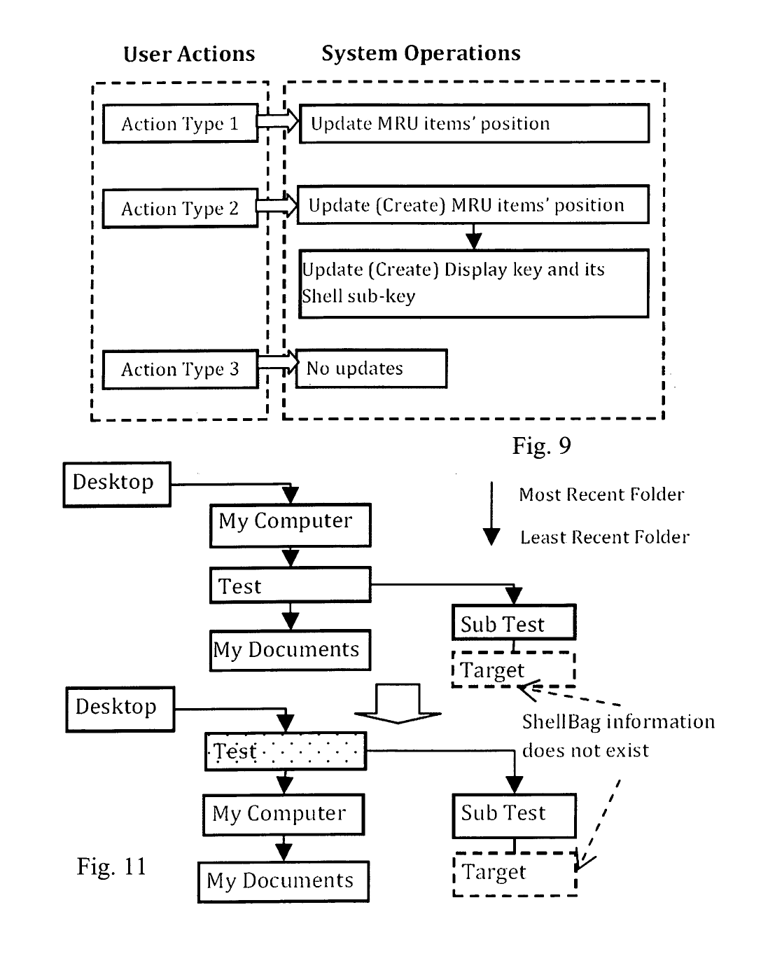

So referring now to FIG. 9, it will be seen that user actions can be broken down into three action types. The first type user action will only update the target folder and its ancestor's MRU items' position if these MRU items exist. If some of these relevant MRU items do not exist within the current Registry, system will not create new item but only update existing MRU items' position. For example in the FIG. 11, the “Target” folder does not have any associated ShellBag information, so when the user executes the first type action on this folder, the system will only update the “Target” folder's ancestor's MRU item's position within the BagMRU key, and stop when it can not match the “Target” folder with any items in the parent folder “Test” MRU key. The “Test” folder's MRU key still maintains the same information as before the action.

The second type of user action will update both the relevant MRU items' position and the contents of the Shell sub-key under the folder's Display key. If the ShellBag information associated with this folder does not exist, system will create it.

The last type of action will not influence any ShellBag information within the Registry.

Given the above generalizations, the characteristics of different types of user actions are summarized in Table 1.

TABLE 1
Summary of User Actions

| | Action Type | | |
|---|---|---|---|
| | Action | Action | Action |
| User Action | Type 1 | Type 2 | Type 3 |
| Open a folder | ✓ | | |
| Close a folder | | ✓ | |
| Create a folder | | | ✓ |
| Delete a folder | ✓ | | |
| Copy a folder | ✓ | | |
| View target folder as | ✓ | | |
| thumbnail within | | | |
| parent folder | | | |
| Create a new file | | | ✓ |
| Delete a file | | | ✓ |

Nonetheless, other user actions that are not listed in this table could be tested and analyzed through the same method.

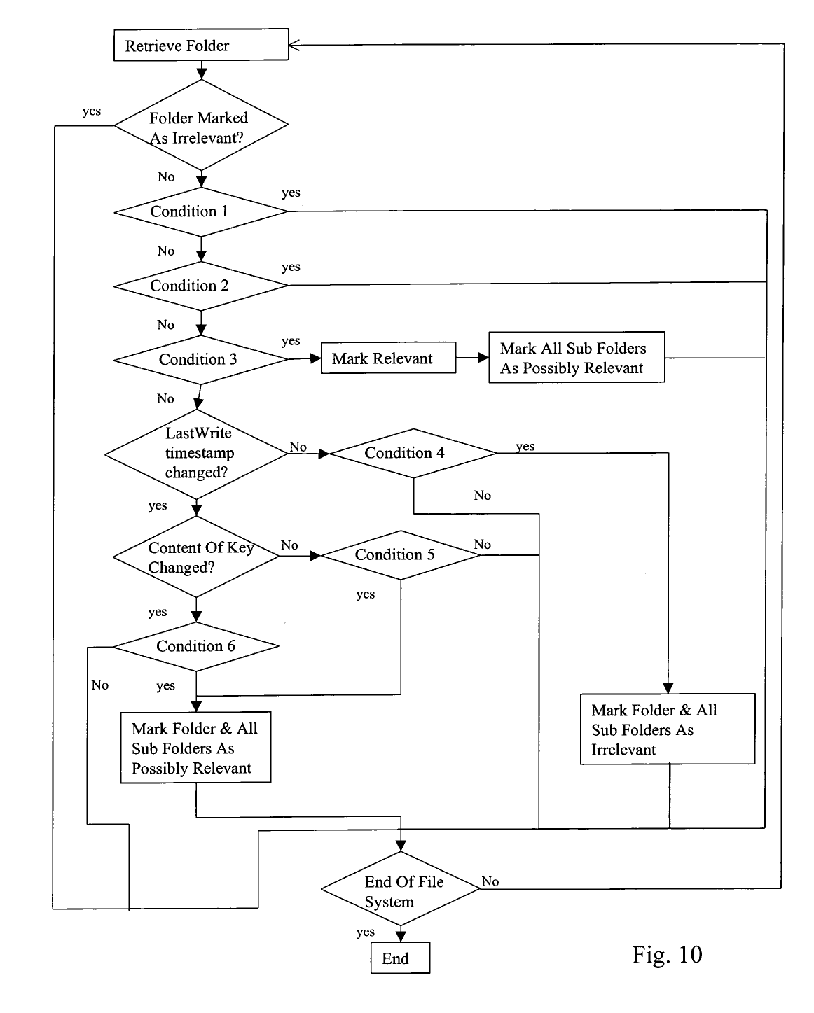

In a second aspect of the present invention, the above updating mechanism for the BagMRU keys and the Bags MRU keys is utilised within a registry analysis tool arranged to analyse consecutive Registry snapshots of ShellBag information by adhering to the following inferences to thereby ascertain those folders used or not used by a given user between the creation time of the preceding snapshot and succeeding snapshot, as illustrated in the flow diagram of FIG. 10.

In one implementation of this second aspect, the folders are labelled as being relevant, possibly relevant, of an unknown status, and irrelevant. A folder is labelled as irrelevant if the tool has ascertained that the folder has definitely not been used during a time lapse between the two consecutive snapshots. A folder is labelled as relevant if the tool has ascertained that the folder has definitely been used during a time lapse between the two consecutive snapshots. A folder is labelled as possibly relevant if the tool has ascertained that the folder has possibly been used during a time lapse between the two consecutive snapshots. A folder is labelled as being of an unknown status by default, if it cannot be determined at the present stage, if the folder has or has not been used.

In one implementation, the registry tool is arranged to compare two consecutive registry snapshots of ShellBag information for each folder. The algorithm starts from checking the Desktop folder and propagates down the structure until it reaches the end of file system.

If a folder has been already marked as irrelevant, it is not necessary to proceed to the following process and tool proceeds to process a next folder in the file system.

If a folder does not have an associated MRU key, MRU item, and Display key, the folder has not previously been used by second type user action. Thus, when comparing two consecutive registry snapshots of ShellBag information, it can be inferred that if a folder does not have an associated MRU key, MRU item, and Display key, the folder has not previously been used by the second type user action.

This condition is illustrated as condition 1 of the flow diagram. Thus if the folder in question is considered to satisfy this condition 1, i.e. the folder does not have an associated MRU key, MRU item, and Display key, it is determined that no update has occurred, and this folder is identified as never used by the second type user action before. The tool then proceeds to process a next folder in the file system if applicable.

However, if both snapshots display an associated MRU key, MRU item, and Display key, for the folder, the tool proceeds to the next condition, condition 2.

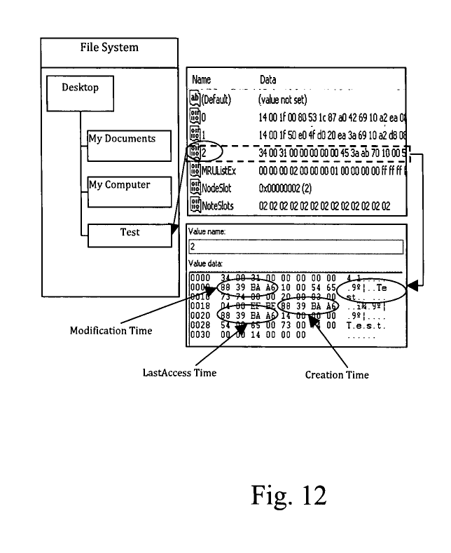

A new folder having the same name as a previous, deleted folder may inherit ShellBag information associated with the previous folder. Thus, it can be inferred that, when comparing two consecutive registry snapshots of ShellBag information, any event occurring prior to the creation of this folder cannot be deemed to be relevant to the folder. One way to examine that is to compare the LastWrite timestamp with the folder's creation time. Another way to examine that is to compare the folder's creation time with the creation time stored within its associated MRU item, as illustrated in FIG. 12.

Illustrated as condition 2 of the FIG. 10, if an update is deemed to have occurred before the creation of the folder, or as in the alternative embodiment, the creation time is not matched, the tool then proceeds to process a next folder in the file system if applicable.

If condition 2 is not deemed to have been met, the tool proceeds to consider condition 3.

A shell key of a Display key associated with a folder is only updated as a result of a user altering viewing preferences and closing the associated folder. Thus, when comparing two consecutive registry snapshots of ShellBag information, it can be inferred that if the viewing preferences relating to a folder have been modified, the modification occurred at the LastWrite time associated with the Shell key, and the folder was used by the second type user action.

This condition is illustrated as condition 3 of the flow diagram. Thus, if the folder in question is considered to satisfy this condition 3, i.e. it is determined that an update has occurred, the folder is marked as relevant and all of the folder's sub folders are marked as possibly relevant. The tool then proceeds to process a next folder in the file system if applicable.

If condition 3 is deemed not to have been met, the tool proceeds to consider the next condition, as illustrated.

If the folder does not satisfy this condition 3, it checks whether the LastWrite timestamp of the key has changed between two snapshots.

When comparing two consecutive snapshots of the ShellBag information, it can be inferred that if the LastWrite stamp relating to an MRU key has not changed during the time lapse between the two snapshots, no MRU item has been updated or only the most recently used item has been updated.

Condition 4 of FIG. 10 determines whether the folder is not listed as the MRU item in the MRU key. If this condition is satisfied, the folder is not the MRU item and therefore marked as irrelevant.

In order for an MRU item associated with a folder to have been updated, each of the MRU items associated with the folder's ancestor folders must have been updated prior to the updating of the folder's associated MRU item. Consequently, when comparing two consecutive registry snapshots of ShellBag information, it can be inferred that during the time lapse between the two snapshots, if a folder's associated MRU item is not updated, then the MRU items associated with its sub-folders have definitely not been updated.

Consequently, all sub-folders of the folder identified as irrelevant are also deemed irrelevant and removed from the list of folders to be examined by the tool. So if the folder satisfies condition 4, the subfolders of this folder are all marked as irrelevant as well. The tool then proceeds to process a next folder in the file system if applicable.

However, if when considering condition 4, the tool identifies the folder as being the MRU item in the MRU key, thereby not satisfying condition 4, the tool then proceeds to process a next folder in the file system if applicable.

In the alternative case, whereby the LastWrite timestamp is deemed to have changed in the elapsed period between the snapshots, the tools proceeds to ascertain whether content of the key relating to the folder was changed in this time period.

When comparing two consecutive snapshots of the ShellBag information, if the LastWrite stamp relating to an MRU key has changed during the time lapse between the two snapshots, but the content or sequence of the MRU items of the MRU key does not appear to have changed, it can be inferred that at least the most recent used item and the second most recently used items have been updated.

Condition 5 of FIG. 10 is arranged to determine whether the folder is listed as the MRU item or the second MRU item in the MRU key. If this condition is not met, i.e., the folder is neither listed as the MRU item, nor the second MRU item, the tool proceeds to process a next folder in the file system if applicable.

On the other hand, if condition 5 is met, i.e., the folder is listed as the MRU item, or the second MRU item, the folder and all it's sub folders are marked as possibly relevant and the tool precedes process a next folder in the file system if applicable.

However, if the content of the key associated with the folder, i.e., the sequence of MRU items is deemed to have changed, the folder is assumed to have been used due to the fact that an MRU item associated with a folder is only updated if the folder or its sub-folders have been used. Thus, when comparing two consecutive registry snapshots of ShellBag information, it can be inferred that if an update event is determined, the update event occurred during the time lapse between the two snapshots, and that the update was as a result of the associated folder or its sub-folders having being used.

Thus, in this implementation, in order to identify the updated MRU items, the MRU analysis method of the first aspect of the present invention as described in relation to FIG. 6 is carried out as condition 6.

Thus, if a folder is determined to have been updated according to condition 6, it is marked as possibly relevant, and all of its subfolders are also marked as possibly relevant.

After this, the tool proceeds to process a next folder in the file system if applicable. It will be appreciated that in order to filter or reduce the number of files to be checked in detail, not all of the filters or conditions set out above need be applied by the tool.

Furthermore, the filters or conditions may be arranged in any order and need not follow the sequence as set out in FIG. 10. For example, conditions may be omitted or applied to folders in parallel as opposed to sequentially.

In a still further aspect, the registry analysis tool of the present invention is adapted for specific analysis of file systems to determine whether folders were used based on changes to viewing preference information associated with that folder.

As explained above, each numerically named sub-key of the key Bags comprises a “Shell” key for storing information relating to the viewing or display preferences of the associated folder in the file system is stored.

Each Shell key associated with a folder comprises ItemPos items. The ItemPos item is a data item describing the position of all files and folders within the associated folder. The Shell key item further comprises a timestamp. The timestamp is the LastWrite timestamp for the key, and is subsequently updated each time the position of the files and folders within the folder are altered. Such an alteration comprises the repositioning of the files or folders within the folder, the deletion of files or folders from within the folder and the creation of files or folders within the folder.

Accordingly, in one implementation of the third aspect of the present invention, an analysis tool is employed to determine whether the files or folders within a specific folder were altered and a time period within which such alteration occurred. If it can be determined that an alteration occurred, it can be therefore inferred that the folder was used at least once in that time period.

In this embodiment, the tool is arranged to traverse each snapshot, comparing the value for the folder's ItemPos item in each snapshot with that of a first value from a first snapshot to identify a value different from that from the preceding snapshot. The timestamp for the Shell key for the changed ItemPos value thereby indicates the last time the ItemPos item was updated and the Itempos is updated value.

If the newly identified updated ItemPos item in a snapshot is identified as having a different value to that of the first identified updated value of the ItemPos from a given snapshot, it can be inferred that the files of the associated folder were altered during the time period that elapsed between the snapshot entries, or two updated timestamps. Furthermore, it can be inferred that the folder associated with the ItemPos item was used at least once in that elapsed time period.

As with the first aspect of the present invention, one example of the applicability of the methods of the second and third aspects of the invention is within a registry analysis tool used in the field of forensic investigation of computers to provides forensic investigators with a comprehensive picture of folders used by a user, thereby eliminating unnecessary examination of folders which have never or rarely been used by the user. It is also possible to identify how the folder is changed and what user action caused the change. Equally the invention finds utility in any application where a history of user's activity is useful including computer security software or personalised advertising.

Also, due to the fact that each user logging on to a computer will have a respective subkey under the root HKEY_CURRENT_USER containing specific detail on any folders used by that user, forensic investigators may avail of the tool in order to rapidly establish a history of activity associated with each user of a computer.

The above embodiments have been described in relation to Windows operating systems. Nonetheless, as mentioned, the invention is equally implemented for other operating systems, for example, Mac OS also stores preferences in .plist (property list) files. Within these plist files, there are also MRU lists, such as the most recent used applications, documents and so on.

The invention is not limited to the embodiment(s) described herein but can be amended or modified without departing from the scope of the present invention.

1. A method for analysing a computing device, the computing device including a non-volatile storage medium in which a set of snapshots is stored, each snapshot comprising at least one most recently used, MRU, key for an application, at least one MRU key having a plurality of elements, said method comprising:
comparing a first MRU key from a first snapshot for a first time and a corresponding second MRU key for a second snapshot for a second time temporally following said first time;
responsive to said second MRU key having a second element identified as less recently used than a first element of said second MRU key and identifying a corresponding second element of said first MRU key as not being less recently used than said first element of said first MRU key, labelling said first element as having been newly modified between said first and second times.

2. The method of claim 1 wherein said snapshot is of an operating system registry at a respective time, wherein the registry comprises the at least one most recently used, MRU, key for an application.

3. The method of claim 1 wherein said snapshot is stored within a system restore point.

4. The method of claim 1 further including the step of:
responsive to identifying an element as newly modified and identifying any elements more recently used than said newly modified element in said second MRU key, labelling said more recently used elements as newly modified.

5. The method of claim 1 wherein said comparing comprises converting said first and second MRU keys into respective ordered lists of elements, wherein an element identified as a MRU element is positioned at an end of the list, with less recently used elements being positioned therefrom in order of decreasingly recent use.

6. The method of claim 1 wherein each of said elements comprise one of: a folder identifier; a file identifier; or an indicator of a user action.

7. A method for analysing a computing device, the computing device including a non-volatile storage medium storing folder information for a windows type operating system and a set of snapshots, each snapshot comprising at least one most recently used, MRU, key indicating user interaction with folders of said operating system during operation of said computing device, at least one MRU key having a plurality of MRU items relating to respective folders, said method comprising:
for at least one folder of said operating system, comparing a related MRU item of first MRU key from a first snapshot for a first time and a corresponding MRU item of a second MRU key for a second snapshot for a second time temporally following said first time including applying a plurality of conditions to said MRU items to determine whether a user interaction event occurred during an elapsed time period separating the two snapshots.

8. The method of claim 7 further comprising responsive to an event being determined as having occurred, marking a folder associated with the MRU item as having been used or not used.

9. The method of claim 7, wherein said item is a folder identifier corresponding to sub-folder of the MRU key's associated folder.

10. The method of claim 7, wherein said user interaction event comprises at least any one of:
a) opening of said item's associated folder;
b) closing of said item's associated folder;
c) deleting of said item's associated folder;
d) copying of said item's associated folder; and
e) viewing said item's associated folder as a thumbnail within a parent folder.

11. A method for analysing a computing device, the computing device including a non-volatile storage medium storing folder information for a windows type operating system, said folders comprising at least one file, and a set of snapshots, each snapshot comprising an item having a timestamp, and said method comprising:
traversing said snapshots to locate a value for a folder, having an associated first timestamp, in a first snapshot of said set of snapshots;
responsive to locating the first value, traversing said remaining snapshots to locate corresponding values for said folder, each having an associated second timestamp, temporally spaced from said first timestamp; and
indicating user interaction with folders of said operating system during operation of said computing device in accordance with the timestamps of different values for folders from different snapshots.

12. The method of claim 11 wherein the timestamp associated with the value is identified when comparing the first snapshot with a preceding snapshot and the value is changed.

13. The method of claim 11 further comprising identifying changed files within the folder in a time period elapsed between the first and second timestamps.

14. The method of claim 11 wherein said value is an ItemPos item, and said item is a Shell key containing said ItemPos.

15. A computer implemented registry analysis tool arranged to carry out the method of claim 1.

16. A computer program product comprising a computer readable medium storing and/or recording instructions in machine readable form which when executed in a computing device cause the computing device to carry out the steps of the method of any of claim 1.
